(19) United States
(12) Patent Application Publication
(10) Pub. No.: US 2010/0257464 A1
(43) Pub. Date: Oct. 7, 2010

(54) System and method for immersive operations intelligence

(75) Inventor: Kevyn M. Renner, El Dorado Hills, CA (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 12/586,430

(22) Filed: Sep. 21, 2009

Related U.S. Application Data
(63) Continuation-in-part of application No. 12/323,793, filed on Nov. 26, 2008.
(60) Provisional application No. 61/032,276, filed on Feb. 28, 2008.

(51) Int. Cl. G06F 3/01

(52) U.S. Cl. 715/757; 715/753

(57) ABSTRACT

Systems and methods are provided for conducting business activities related to an industrial facility to achieve immersive operations intelligence. Immersive technology is used visualize a subject facility, and to access resources that may be required to design, test, operate, maintain and improve the facility. Resources may include personnel, data, models, work flows, historical data, and real-time data, e.g., audio, video, sensor, instrumentation data, etc.

### RELATED PATENT APPLICATIONS

This application is a continuation-in-part of U.S. application Ser. No. 12/323,793, filed on Nov. 26, 2008, entitled “Method and Systems for Conducting a Meeting in a Virtual Environment,” which claims priority to U.S. Provisional Patent Application Ser. No. 61/032,276, filed on Feb. 28, 2008, entitled “Method and System for Real Asset Collaboration in a Virtual Environment,” the contents of all of which are incorporated herein in their entirety by reference.

### FIELD OF THE INVENTION

The present invention relates to systems and methods for remotely conducting business activities related to an industrial facility, and in particular, systems and methods for operating and maintaining industrial facilities utilizing immersive operations intelligence.

### BACKGROUND OF THE INVENTION

Business enterprises are constantly under pressure to improve productivity and maintain growth with a limited amount of personnel and other resources. In particular, global business enterprises may have personnel and technology resources, such as engineers and other experts, distributed among a variety of geographically dispersed facilities or locations. Getting the appropriate personnel in one place at one time for training, knowledge sharing, or troubleshooting can be difficult, expensive, and often not timely enough to address urgent needs of the business. See U.S. patent application Ser. No. 12/323,793 entitled “Methods and Systems for Conducting a Meeting in a Virtual Environment, which for example discloses systems and methods of conducting a meeting between a plurality of users in a virtual environment.

In order to fully utilize the capabilities of such virtual environments in an industrial facility, systems and methods must exist that present “contextual data” so as to truly provide an immersive experience for the user. While virtual environment tools such as Second Life and Qwaq's Forum technologies provide on-line conferencing and collaborative capabilities, such tools are do not provide truly immersive references to the industrial facility and real-time operations thereof.

Further, many present day industrial facilities utilize control, monitoring, inspection, reporting and other information systems having limited interoperability and limited focus on so-called “operations intelligence.” Such systems typically produce massive amounts of data, resulting in a virtual “cloud of context” with respect to the operation of the industrial facility. If not presented in an optimal way, this “cloud” can hinder or prevent “intelligent” operation of the facility.

As such, a need exists for an immersive technology, implemented using computer technology, to visualize a subject facility, and to access different types of resources that may be required to design, test, operate, maintain and improve the facility. Resources may include personnel, data, models, work flows, historical data, and real-time data (e.g., audio, video, sensor, instrumentation data, etc.).

A further need exists to present operations, inspection, maintenance and other data to enables immersive operations intelligence of an industrial facility.

### SUMMARY OF THE INVENTION

A computer-implemented method is provided for conducting activities related to an industrial facility. The method includes the steps of defining one or more facility activities to be performed by a defined set of users, such as training, scheduled or unscheduled maintenance, procedure development, etc., and generating a collaboration environment for the users, which for example may include a virtual conference room having graphical representations for each of the users. The method further includes the step generating an virtual representation of the industrial facility, for example in the form of a 3-D graphical model, providing operations data (e.g., real-time, historical or prognostic operations, maintenance, inspection, document management, or other data) related to the industrial facility, and receiving and processing, at one or more locations remote to the facility, data representative of the users, data representative of the collaboration environment, the virtual representation and the operations data.

The method then generates and displays an immersive visual environment to enable the users to collaboratively conduct the facility activities from the one or more remote locations. As such, the method of the present invention can be used to more effectively train personnel, enhance safety, and improve the repeatability, clarity and quality of facility-related activities. The method and system described below thus enable immersive, intelligent, and optimized operations (collectively “immersive operations intelligence”) of industrial facilities such as refineries, power plants, manufacturing facilities and the like.

In accordance with another aspect of the invention, a computer controlled system is provided for conducting activities related to an industrial facility. The system includes a collaboration environment server for executing a first set of computer instructions to produce a collaboration environment for a defined set of users and for defining one or more facility activities to be performed by the users; a virtualization environment server for executing a second set of computer instructions to produce a virtual representation of the industrial facility; at least one facility environment server for executing a third set of computer instructions to provide operations plant data; user terminals located at one or more locations remote from the facility in communication with the collaboration environment server, the virtualization environment server and the facility environment server for executing a fourth set of computer instructions for receiving and processing the data representative of the users.

The system further includes a user display device in communication with each of the user terminals for displaying an immersive visual environment of the facility to enable users to collaboratively conduct the facility activities from the one or more remote locations.

Non-limiting advantages of the present invention include increased overall safety reliability and performance of the industrial facility, with reduced costs, hazards and environment impacts. For example, by providing a collaborative immersive environment having “in-room,” “ad-hoc” contextual information, an expert remotely located from a plant can “virtually” participate in a meaningful way to enhance decision making, thus eliminating the time, costs, risks and environment impacts associated with physically transporting and co-locating the expert in the plant with peers and/or the contextual information. Implementation of the present invention can further enhance the quality of decision making, improve execution of work processes, reduce incidents and injuries, and lead to fewer and shorter scheduled and unscheduled plant or equipment shutdowns.

### BRIEF DESCRIPTION OF THE DRAWINGS

A detailed description of the present invention is made with reference to specific embodiments thereof as illustrated in the appended drawings. The drawings depict only typical embodiments of the invention and therefore are not to be considered to be limiting of its scope.

FIG. 1A is a block diagram of an exemplary system in accordance with the present invention.

FIG. 1B is a flow diagram of an exemplary method in accordance with the present invention.

FIG. 2 is a block diagram of an exemplary server that executes a computer program to produce a virtual environment in accordance with the present invention.

FIG. 3A-3D is a block diagram illustrating an exemplary virtual conference room in accordance with the present invention.

FIG. 4 is a flow diagram of another exemplary method in accordance with the present invention.

FIG. 5 is a schematic diagram of a system in accordance with the present invention.

FIG. 6 is flow diagram of a method in accordance with the present invention.

FIGS. 7-9 are illustrations of exemplary displays in accordance with the present invention.

### DETAILED DESCRIPTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multi-processer computer processors system, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

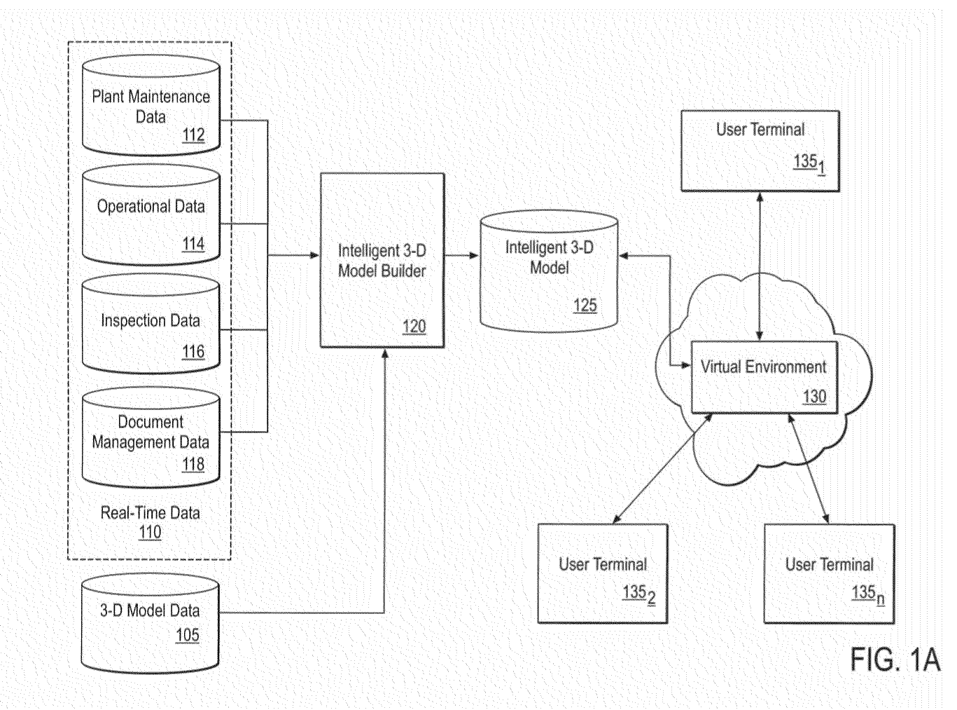

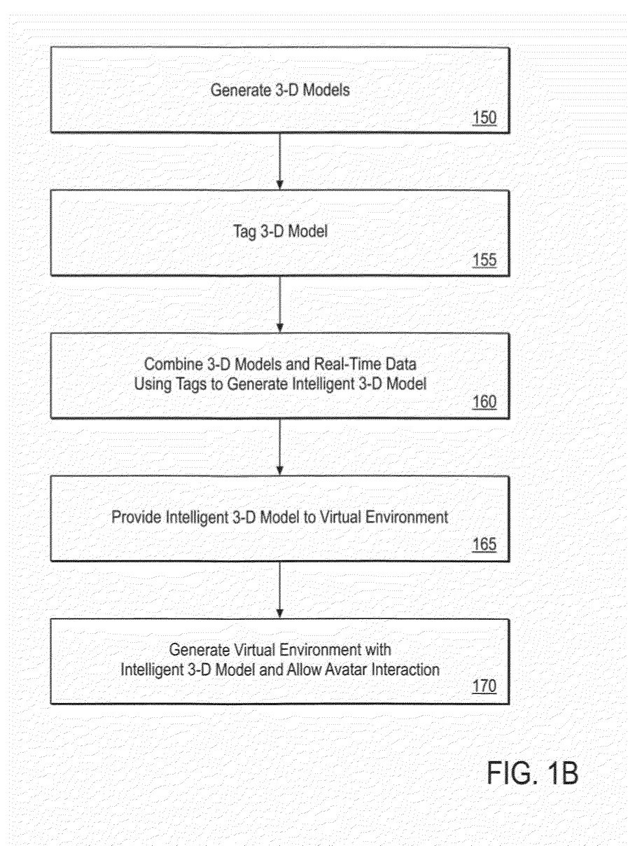

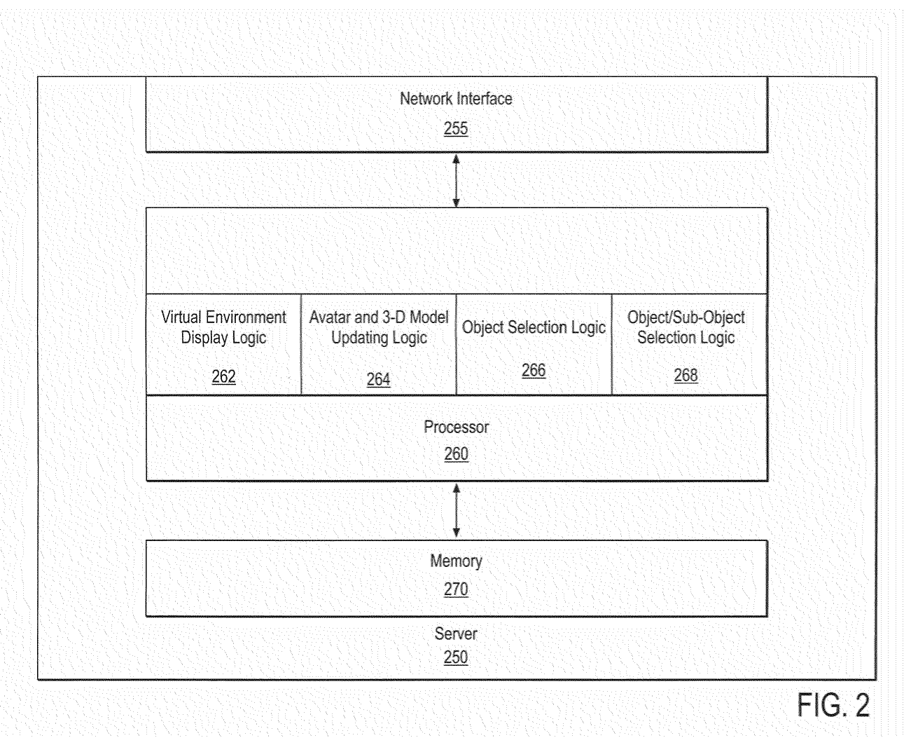

The present invention relates to a system and method for operating an industrial facility by utilizing immersive technologies. FIG. 1A is a block diagram of an exemplary system in accordance with the present invention. The system includes a plurality of user terminals 135₁-135ₙ coupled to virtual environment 130. User terminals 135₁-135ₙ can be any type of user terminal, including, but not limited to, desktop computers, laptop computers, personal digital assistants (PDAs), wireless telephones, smart phones and/or the like. As will be described in more detail below in connection with FIG. 2, virtual environment 130 is executed on a server.

An intelligent, location accurate, 3-D model of a manufacturing facility 125 is also coupled to virtual environment 130. Intelligent 3-D model 125 is coupled to intelligent 3-D model builder 120, which in turn is coupled to 3-D model data database 105, and operations data databases 110. Operations data databases include plant maintenance data database 112, operational data database 114, inspection data database 116 and document management system data database 118. Other types of operations data can be employed in addition to, or as an alternative to, those illustrated in FIG. 1A. One or more of the elements of FIG. 1A can be coupled to each other by way of any type of network, such as, for example, the Internet.

Overall operation of the system will now be described in connection with the flow diagram of FIG. 1B. Initially, one or more location accurate 3-D models of a manufacturing facility are generated and populated into database 105 (step 150). The 3-D models can be generated using, for example, laser scanning techniques, such as those provided by INOVx of Irvine Calif. Alternatively, or additionally, the object models can be created by conversion of 2-D or 3-D computer-aided design (CAD) files. The 3-D models can be designed with any desired tolerance, such as five millimeters. Thus, for example, although a piping is designed to be perfectly vertical, the 3-D model can reflect any variance in the horizontal direction.

Various elements of the 3-D models that will be updated with operations data are tagged (step 155). These elements can be any elements, such as objects, sub-objects, components, structures, circuits, sub-system and/or the like. Intelligent 3-D model builder 120 then uses the tags to combine the 3-D model data with operations data to generate an intelligent 3-D model (step 160). The 3-D model is “intelligent” in that it is based on both structural and operational information, and it is also updated based on operations data. The intelligent 3-D model is stored in database 125, which provides the model to virtual environment 130 (step 165). As will be described in more detail below, the virtual environment 130 generated using the 3-D model allows interaction between the model and avatars representing users of terminals 135₁-135ₙ (step 170). Although not illustrated, the 3-D model itself can be updated to reflect structural changes, such as new elements, rearrangement of elements, etc.

Now that an overview of the generation of the virtual environment has been provided, a description of the operation of the virtual environment will be described in connection with FIGS. 2-4. FIG. 2 is a block diagram of an exemplary server that executes a computer program to produce a virtual environment in accordance with the present invention. The server 250 includes a network interface 255 to exchange information with user terminals 135₁-135ₙ and with intelligent 3-D model database 125. Network interface 255 is coupled to processor 260, which in turn is coupled to memory 270. Processor 260 includes logic 262-268, which will be described in more detail below. Processor 260 can be any type of processor including a microprocessor, field programmable gate array (FPGA), application specific integrated circuit (ASIC) and/or the like. When the processor is a microprocessor, logic 262-268 can be processor-executable code loaded from memory 270.

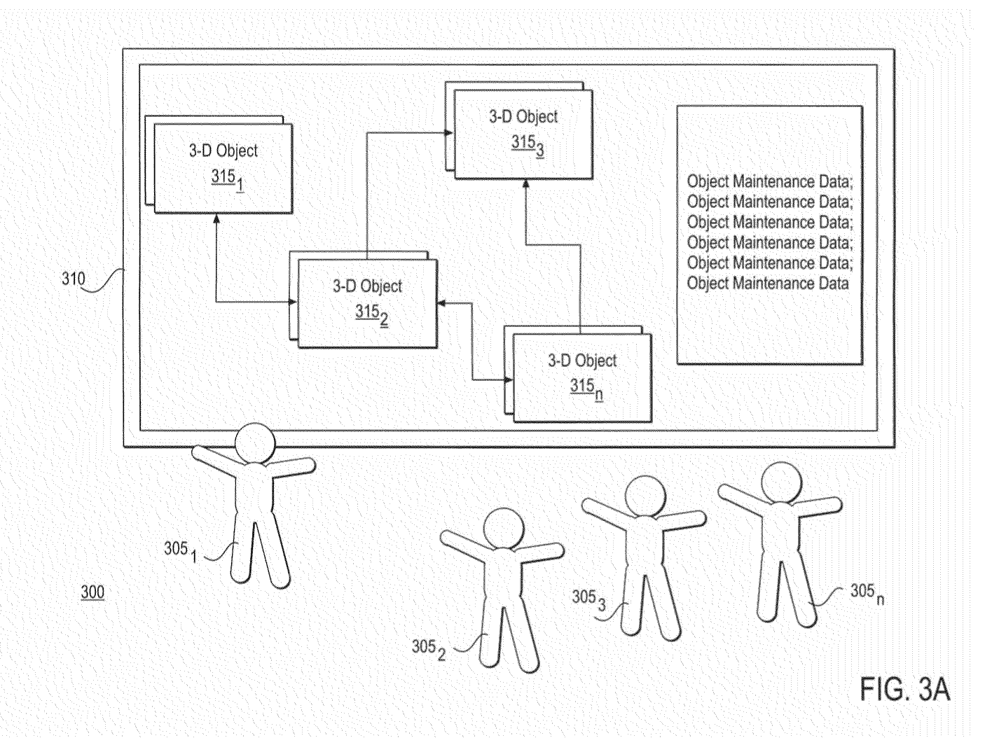

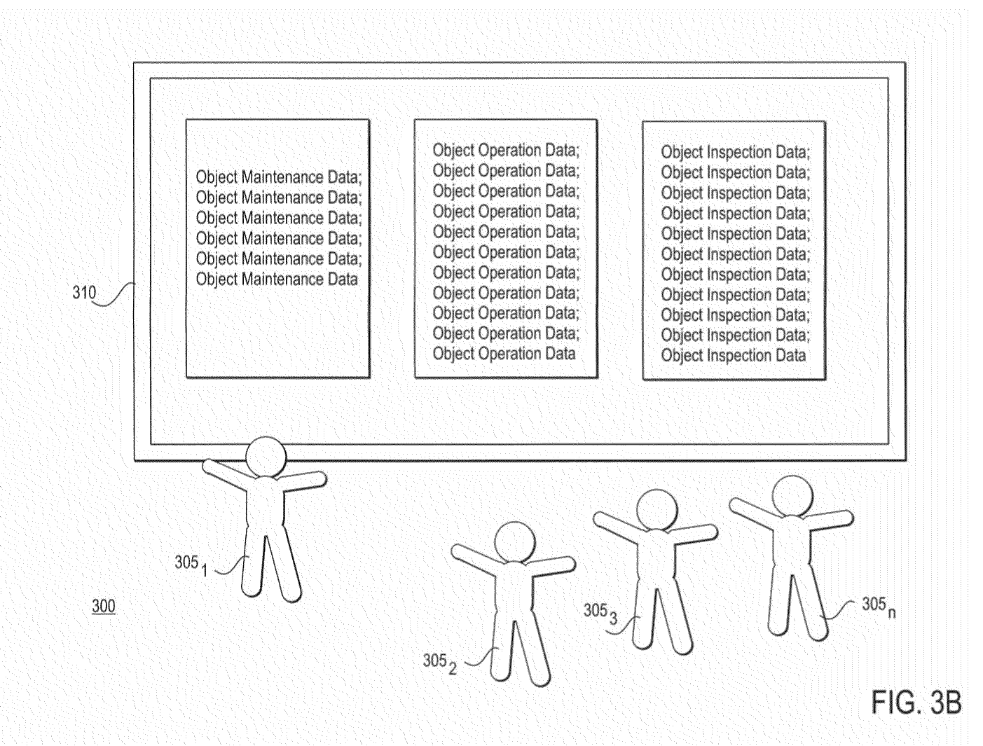

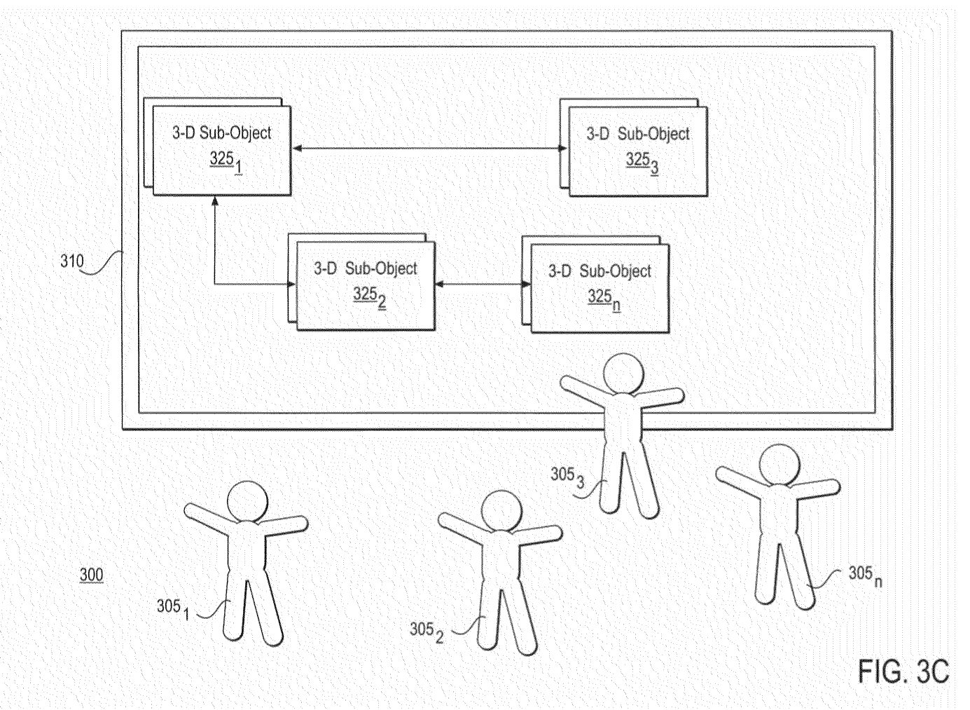

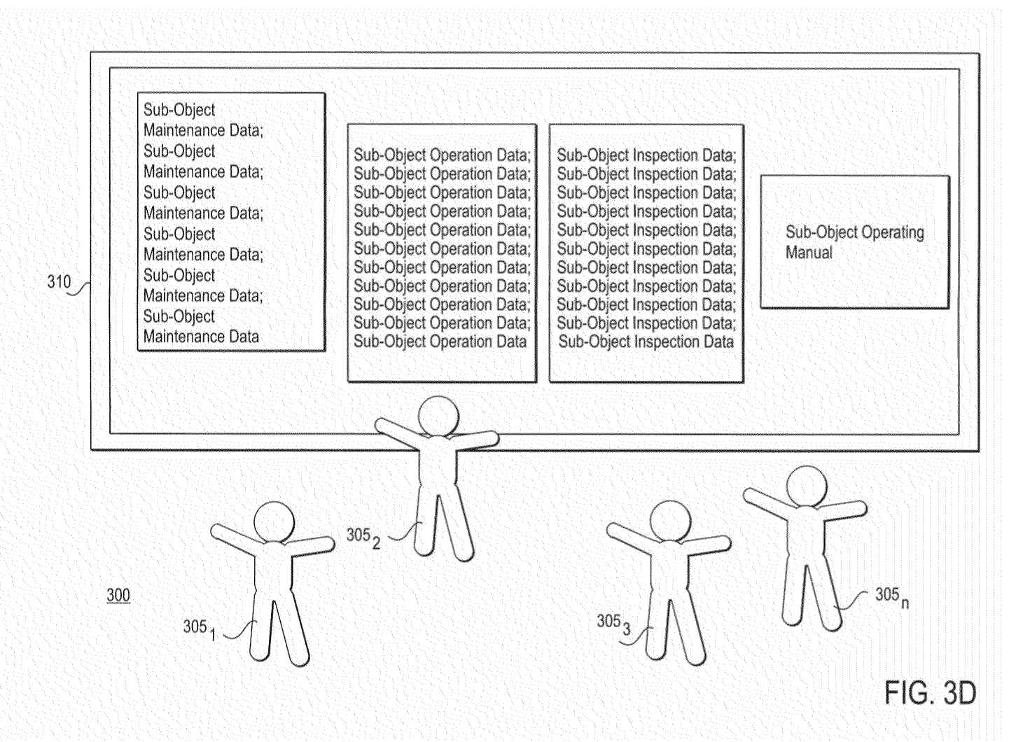

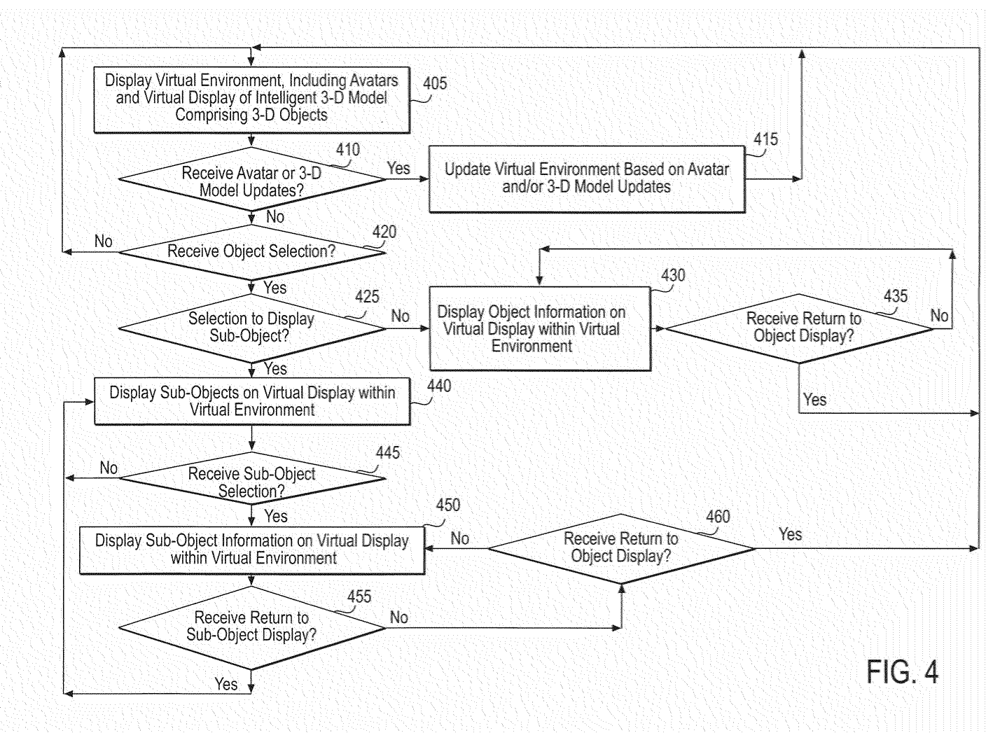

Turning now to FIGS. 3A and 4, logic 262 initially displays a virtual environment that includes avatars 305₁-305ₙ, and virtual display 310 that includes an intelligent 3-D model comprising 3-D objects 315₁-315ₙ (step 405). Depending upon the type of manufacturing facility represented by the intelligent 3-D model, the objects can be, for example, one of a vessel, rotating machinery, separation equipment and vessels, mixing equipment and vessels, reaction equipment and vessels, associated valves, piping, instrumentation elements and/or other structures. The virtual display can also display additional information, such as, for example, object maintenance data.

Although FIG. 3A illustrates a particular number of avatars and a particular number of objects comprising the 3-D model, the present invention can be employed with greater or fewer numbers of avatars and/or objects comprising the 3-D model. Furthermore, the arrangement of the objects of the 3-D model is merely exemplary and the objects can be arranged in a different manner. Additionally, the present invention can also be employed with more than one display. Although not illustrated, the virtual environment can include more than one virtual conference room and/or virtual display. Furthermore, the virtual conference room can include a virtual whiteboard, as well as elements for capturing avatar notes and comments, such as flip charts, attached text or audio comments and/or the like.

Logic 264 then determines whether server 250 has received an avatar or 3-D model updates (step 410). Avatar updates can include the addition or removal of avatars due to user terminals or sessions joining or leaving the virtual environment and/or movement of avatars within the virtual environment. 3-D model updates can include updates based on operations data 110. When logic 264 determines that such updates have been received (“Yes” path out of decision step 410), then logic 264 updates the virtual environment (step 415), and logic 262 displays the virtual environment with the updated information (step 405).

When avatar or 3-D model updates have not been received (“No” path out of decision step 410), then logic 266 determines whether a 3-D object selection has been received (step 420). A 3-D object selection can be performed using an input device at one of the user terminals 135₁-135ₙ, movement of an avatar within the virtual environment to select the object and/or the like. The input device can be any type of input device including, but not limited to, a keyboard, keypad, mouse, pen input device, trackpad, trackball and/or the like. When an object selection has not been received (“No” path out of decision step 420), then logic 262 continues to display the virtual environment (step 405).

When, however, an object selection is received (“Yes” path out of decision step 420), then logic 268 determines whether the selection is to display information about the selected object or to display sub-objects of the selected object (step 425). The information can be, for example, maintenance data, operational data, inspection data or a document associated with the selected object. When logic 268 determines that the selection is to display information about the selected object (“No” path out of decision step 425), then, as illustrated in FIG. 3B, logic 262 displays the object information on display 210 (step 430). Users can interact with the data using an input device of the user terminal and/or avatars until one of the user's requests that display 210 be returned to the state where it displays the 3-D model comprising the 3-D objects (“Yes” path out of decision step 435).

When the object selection is to display the sub-objects of the selected object (“Yes” path out of decision step 425), then, as illustrated in FIG. 3C, logic 262 displays the 3-D sub-objects 325₁-325ₙ (step 440). When a sub-object selection is received (“Yes” path out of decision step 445), then, as illustrated in FIG. 3D, logic 262 displays the sub-object information within the virtual environment (step 450) until logic 262 receives a request from one of the users and/or avatars to return to the sub-object display (“Yes” path out of decision step 455) or to return to the object display (“Yes” path out of decision step 460).

Although the figures above illustrate particular information being included on the displays, the present invention is not so limited. For example, the displays can provide “knowledge views” that combine various views for added perspective. For example, structural steel and piping views can be combined so that proper access and routing can be planned and communicated to turnaround staff. Scaffolding plans can be laid over the views to ensure suitability. Similarly, the present invention provides the ability to subtract views to provide a better understanding of a particular environment. The views, including the knowledge views, can be panned, zoomed and otherwise navigated to gain a full perspective.

The present invention can also provide a querying capability. Thus, for example, a query for all pipes containing sour gas and having a corrosion rate greater than 4 mils/annum and an operating temperature greater than 500 degrees can be performed to produce an intelligent 3-D model of such pipes. This would involve pulling data from the various databases to identify such pipes.

In addition, the present invention can provide a simulation and playback capability to create movie-like depictions of scenarios and events, which would support training, learning and reviews of upsets and recovery processes. This capability can also include the ability to add annotations that persist in the context for developing procedures and advancing best practices among the viewers of the depictions.

The present invention can be used in a variety of contexts. For example, if an upgrade project is planned for motor operated valves, power lines, power poles and junction boxes feeding the valves can easily be located and identified. The present invention can also be employed for determining optimal lineups, sequencing of actions, back flushing volumes, etc. Similarly, the intelligent 3-D models allow inspects to determine scaffolding needs, access limitations and safety requirements prior to visiting the actual physical plant. The databases can also include information about dynamic assets, such as cranes, that may be temporarily deployed at a plant.

An exemplary use of the present invention can be for repairs. Accordingly, the intelligent 3-D model can be coupled with a temporary repair database in order to determine all opportunities for permanent repair within the boundaries of any turnaround activity or work order involving a shut down. This can involve the querying capability discussed above. Furthermore, work orders can be precisely linked to the target equipment or systems to provide the most current asset. The present invention also allows for the work orders to be linked with the necessary scheduled support, such as forklifts, scaffolding, etc.

As described above, the present invention is used for conducting a meeting in a virtual environment using intelligent 3-D models of a manufacturing facility. This is particularly advantageous for use to improve manufacturing facility and asset operation, maintenance, and training. For example, instead of requiring a number of persons to travel to a single manufacturing facility to evaluate the operation and/or maintenance issues with the facility, these issues can be addressed with one or more of the people being located at remote locations. Further, instead of requiring people to travel to a particular facility to train on the operation of one or more components (e.g., machines) of the facility, these people can be remotely trained using the present invention. The use of operations data in the intelligent 3-D model leads to a reduction in travel costs, allows full participation by all persons, and does not require taking valuable manufacturing equipment off line for training and maintenance purposes, which is expensive and disruptive to the manufacturing process. Furthermore, the virtual environment produces significant safety advantages by reducing the time personnel spend within a live plant environment.

The use of intelligent 3-D models provides significant advantages over conventional 2-D drawings. Whereas 2-D drawings (e.g., isometric drawings) are prone to misunderstanding, the 3-D models of the present invention allow for easy comprehension of the modeled element. Furthermore, 2-D drawings typically reflect only the design of the system, whereas the intelligent 3-D models of the present invention not only represent what was actually built, but also any later improvements or other developments. Additionally, typical 3-D models are static and are not updated as modifications are made to process equipment, whereas the intelligent 3-D models of the present invention account for modifications.

An example of the above-described system of FIG. 1A is now described with respect to a oil refinery facility. Advantageously, the immersive environment can be used to collaboratively manage, operate and maintain the refinery facility without the co-location of key personnel. For example, multiple refining Subject Matter Experts (SME's) can collaborate around Asset Models no matter where the location, in a standard, internet-based space. Refining workers can rehearse or execute multiple work processes without being physically present in the operating refinery, and will minimizing risk to personnel and equipment. Workers can be trained on actual representations of the refining equipment prior to being in the refinery, or, prior to plant being built and commissioned. Such an environment would enable virtual analysis, training, operational execution and collaboration from multiple locations while at the same time being based on industry standard, web-based communication technologies allowing for sustainability and interoperability with adjunct refining sub-systems.

The immersive environment can further be used to capture knowledge and best practices related to work processes in software for later use. By facilitating the capture and implementation of best practices, the immersive environment can be used to implement work processes the further enhance the safety, reliability and performance of the refinery facility.

In accordance with one embodiment of a refinery immersive environment, the immersive environment provides a virtualization capability, which includes a degree of digital/graphical representation of refining assets such that personnel may analyze, train and collaborate from multiple locations without immediate need to physically be in the operating plant. The following embodiments will be described in reference to three illustrative use cases conducted at a Vacuum Gas Oil/Sulfur Recovery/Tail Gas Unit of an operating refinery: (1) operational maintenance; (2) HAZOP analysis; and (3) operator training.

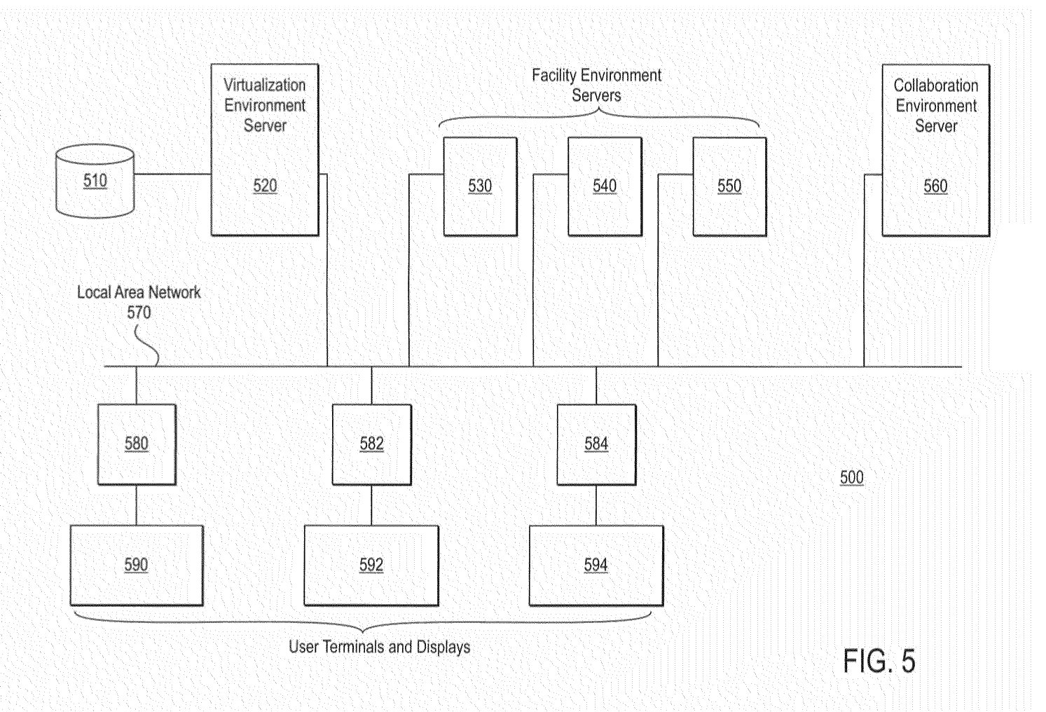

FIG. 5 shows an exemplary architecture diagram for a refinery immersive environment system 500 in accordance with the present invention. The system includes a virtualization environment server 520 and virtualization environment database 510 coupled to one or more user or client processors 580-584 for establishing a virtual environment at corresponding terminal displays 590-594. The virtualization environment server 510 can execute code, such as INOVx's RealityLINx, which enables users at each of the terminals 590-594 to virtually navigate through a refinery facility. The virtualization environment server 520 is coupled to a corresponding database 510, which contains physical 3D models and related data corresponding to equipment, structures, and the physical arrangement of the refinery.

System 500 further includes one or more facility environment servers 530-550 and associated databases (not shown), for providing operations, inspection, maintenance and other data related to the industrial facility. Such facility environment servers are configured to execute computer program code such as PI, PASSPORT and MERIDIUM for providing the operational, maintenance and inspection/reliability data, respectively. A collaboration environment server 560 executes computer program code, such as Qwaq's Forum software, for creating a collaborative environment or virtual meeting or control center for conducting activities related to the industrial facility. Each of the virtual environment, facility environment, and collaborative environment servers 520-560 are coupled to the client or user processors or terminals 580-584 via a communications media, shown for example as a local area network 570.

Each of the virtual environment, facility environment, and collaborative environment servers are also in communication with one or more interfaces, installed for example at each of the user processors, for enabling compatibility and queries related for example to the 3-D models, operations, maintenance, inspection, reliability and collaborative environment data. Additionally, one or more interfaces may be provided to manually or automatically update 3-D model information with real-time, historical or trend or prognostic data, for example by tracking common or frequently performed maintenance work orders and work order tasks in PASSPORT or equivalent application as a means for updating the model or immersive environment workflow. Updating the 3-D model could be performed manually or automatically based upon one or more selected criteria, for example, a certain type of work order (e.g., replace or reconfigure equipment) or occurrences of a certain work order or set of work orders, an accordingly, an appropriate portion of the plant can be re-laser scanned and the model updated from the resulting 3D images. When laser scanning is done to create or update the 3-D model, a GPS record is kept of the location of the laser equipment so that a laser location can be readily reproduced in the plant so that the information can be provided with the model.

In one embodiment of the present invention, data from the virtual environment and facility environment servers is organized in accordance with a hierarchical structure representative of the industrial facility, e.g., division, unit, equipment type, equipment number, component type, component number, etc. This enables the mapping of real-time operations, maintenance, inspection and other facilities data from the facility environment servers to the various equipment (e.g., compressor), locations (e.g., process piping) and datapoints (e.g., elbow on a process pipe) depicted by the 3-D model representations generated by the virtualization environment server. Such interfaces between the virtualization environment and facility environment servers can enable the visual tagging of operational data, such as temperature and pressures, to physical assets, such as valves, pumps, control units, etc., in the facility design model. The virtualization environment server, for example, can provide the following functionality for each of the visual tags corresponding to the physical assets of the 3-D facility model: (1) latest value of the operational parameter, including the time stamp, units, and description, (2) values in tabular form for the last 24 hours, and (3) values in tabular form for any specified time period.

Referring again to FIG. 5, each of the user processors 580-584 include computer program code that generates various human machine interfaces (HMIs) or displays at display devices 590-594 for creating an immersive environment for conducting activities related to the facility. The devices 590-594 display visual representations of the various 3D facility models that allow the user to view equipment and the refinery layout “as built” and “to scale.” The displays present an immersive view of the facility that allows the user to perceive equipment and facility dimensions, clearances and accessibility, from a remote facility, as if the user were actually in the facility. As such, the system enables and promotes immersive operations intelligence with respect to data and operations related to the industrial facility.

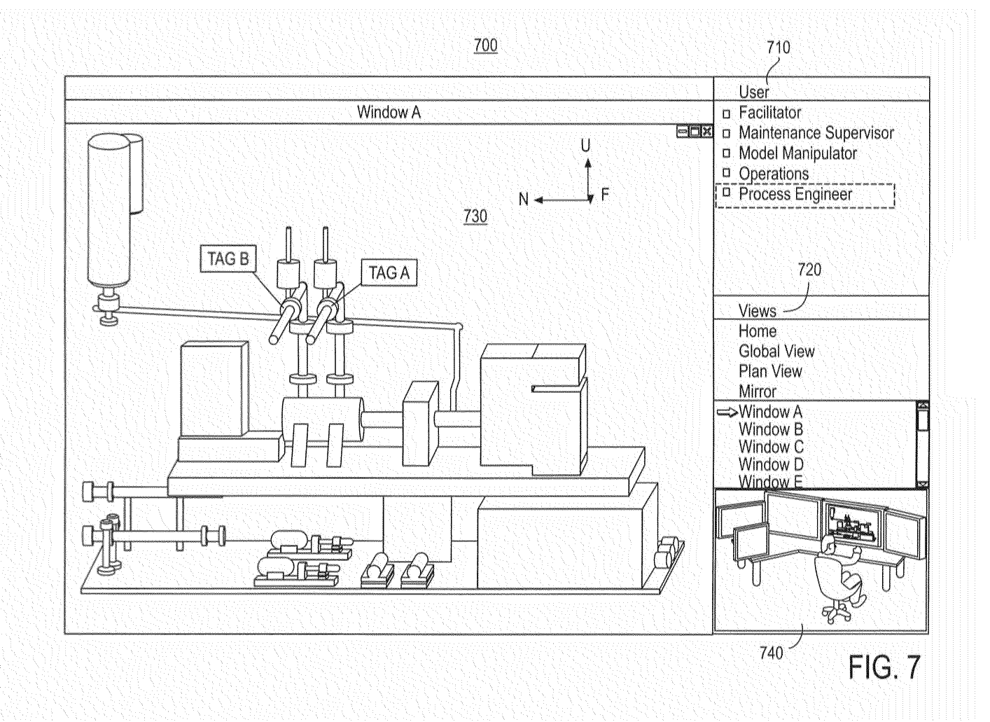

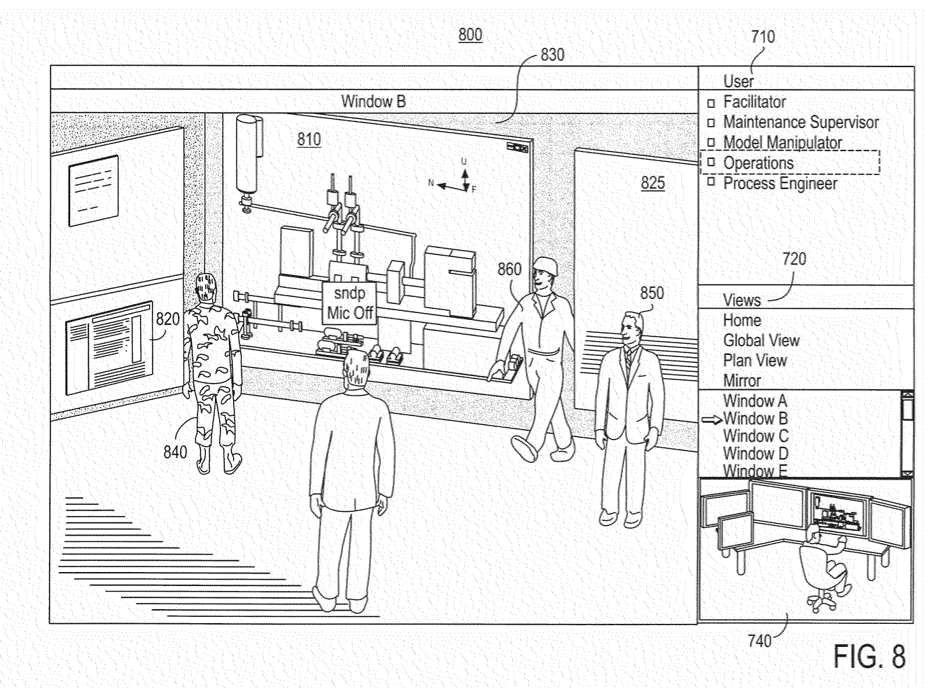

FIGS. 7 and 8 are illustrations of exemplary immersive displays in accordance with the present invention. Displays 700 and 800 both include regions 710, 720 and 740 for displaying user, view and virtual meeting room information, respectively. Region 710, in the both FIGS. 7 and 8, include a listing of users or participants in the collaborative effort. In this case, the collaborative effort corresponds to the troubleshooting and maintenance of equipment within the industrial facility. Users include a facilitator for initiating and facilitating the collaborative effort, and a maintenance supervisor, operations personnel and process engineer for evaluating the equipment and planning, documenting and executing maintenance activities. With reference to FIG. 8, the users can be represented for example by avatars 840-870. Region 720 includes various options for views of the virtual meeting room, e.g., Home, Global View, Plan View, Mirror, and various Window displays. A Global View, for example, corresponds to the various views of the virtual conference room shown in Region 740.

Windows shown in FIGS. 7 and 8 correspond to selected visual representations 730 (3-D model) and 830 (virtual collaboration space or conference room) of information generated by one or more of the virtualization, facility and collaboration environment servers of FIG. 5. In the case of FIG. 7, for example, Region 730 shows a Window A, which is a 3-D model representation of a certain piece of equipment within a refinery facility. Also included is visual tag information that provides real-time data, such as temperature or pressure, and statistics for the corresponding equipment, location or datapoint of the facility. The model can be manipulated by a model manipulator, who can assist other users to virtually navigate through the 3-D model.

In the case of FIG. 8, Region 830 shows Window B, which is a view of the virtual conference room from the perspective of the process engineer 870. Region 830 shows the operations personnel 870 reviewing a 3-D model of the facility shown in Region 810. Also displayed in Region 820 is a procedure that the users are in the process of preparing. Other information, such as a Piping, Instrumentation Diagram (P&ID) of the facility, and can shown in any of the “console” Regions 810, 820 or 825. The view shown in 830 also shows the presence of the facilitator 840, maintenance supervisor 860 and process engineer 850 in the virtual collaboration environment.

Alternatively, with reference to FIG. 8, the avatars can be designed to “travel” in and out of the 3-D model from their locations within the virtual conference room shown in 830. In another embodiment, the 3-D models can be designed to be “ported” from the Region 810 into the center region of the virtual conference room so that each of the users 840-870 can view the 3-D model from their respective virtual positions within the virtual conference room.

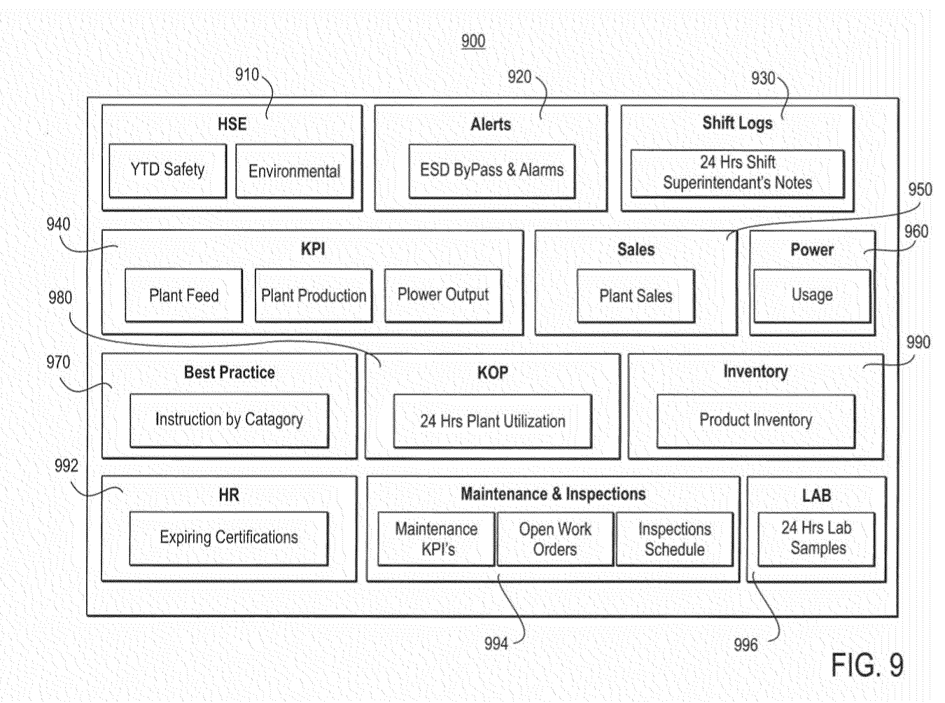

FIG. 9 is an example of another display that can be presented in any of the Regions 810, 820 or 825 of the virtual conference room. The display includes various regions 910-996 for displaying a facility dashboard, including for example, health, safety and environmental data 910, alerts 920, shift logs 930, plant feed and production data 940, sales data 950, power usage data 960, best practices data 970, plant utilization data 980, inventory data 990, human relations related data 992, maintenance and inspection data 994, and laboratory data 996.

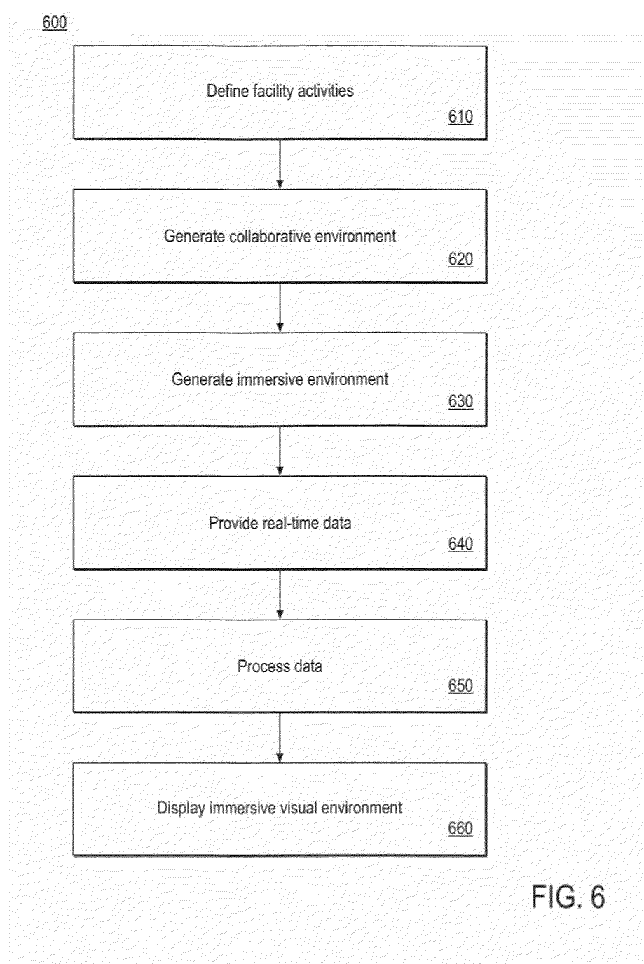

The system of FIG. 5, including the displays and method described below with reference to FIG. 6, thus allow operators of an industrial facility to achieve immersive operations intelligence that enables more efficient aggregation of data, discovery of abnormal conditions, contextualization of data, facility modeling, analysis of potential problems, and propagation of solutions.

FIG. 6 shows an exemplary method 600 for conducting activities related to an industrial facility. The method 600 includes the steps of: defining one or more facility activities to be performed by a defined set of users (Step 610); generating a collaboration environment for a defined set of users (Step 620); generating an virtual representation of the industrial facility (Step 630); providing operations data (including real-time or historical or prognostic operational, maintenance, inspection, document management or other data) related to the industrial facility (Step 640); receiving and processing data representative of the users, data representative of collaboration environment, the virtual representation, and the operations data, at one or more locations remote to the industrial facility (Step 650); displaying an immersive visual environment using the user data, collaborative environment, virtual representation, and operations data to enable the users to collaboratively conduct the facility activities from the remote locations (Step 660). In accordance with a non-limiting embodiment of the present invention, the above steps can be initiated or controlled from the collaboration environment server 560 of FIG. 5.

The method may be applied, by way of example and not limitation, to perform facility operations and maintenance planning, including scheduled and unscheduled maintenance of plant equipment, turnaround planning and execution, plant and/or equipment start-up and shutdown planning and execution, and development of new plant and/or equipment operating procedures, including HAZOP and other safety related procedures. Other applications of the claimed method include crisis response planning and execution, operator training, new plant model reviews, knowledge capture, work process improvements, and other activities related to immersive operations intelligence.

In accordance with one application of the present method, the method 600 was used for conducting a scheduled shutdown and maintenance of rotating equipment, e.g., a compressor, which was exhibiting abnormally high vibration characteristics as per analysis of facilities data from PI, PASSPORT and MERIDIUM. Servicing operations were selected from a group of general maintenance, isolation, cleanup, open, close and steam-out operations to be performed by operations engineering and maintenance engineering personnel. The method was used to facilitate collaboration between operations personnel, maintenance personnel, remotely located Subject Matter Expert (SME), and Vendor personnel. The participants were invited to participate in a virtual meeting via the Qwaq Forum collaboration environment. A facilitator initiated the virtual meeting by launching a corresponding 3-D Model via the virtual meeting room, and then initiated a dialogue among the meeting participants to develop a shutdown plan. All required participants logged into the virtual meeting and launched their corresponding avatars. Documents were made available and accessible inside the virtual meeting room, and the shutdown plan was completed and approved inside virtual meeting room and distributed to the appropriate actors.

Data used for this application included (1) standard plant operating procedures for startup, shutdown, cleanup, lock-out and tag-out operations; (2) special refinery operating instructions; (3) emergency procedures; (4) job aids; and (4) normal plant operating procedures. P&ID's in .PDF format were accessed through Qwaq Forum. .DOC files were viewed and edited together in Qwaq Forum. PI data is accessed via a RealityLINx-PI interface.

By creating an immersive visual environment, the users/participants were able to virtually collaborate to more quickly identify the faulty equipment and devise a shutdown and maintenance plan.

A second application of the present method included evaluation and review of equipment/unit for Hazardous Operations, utilizing multiple experts that were located remotely. The application focused on visualizing the equipment via the immersive environment to collaboratively devise a set of HAZOP procedures. Meeting participants included a facilitator, operations personnel familiar with the plant, a process engineer, a corporate HAZOP expert, a mechanical engineer and various other SMEs. The HAZOP analysis was conducted in the virtual meeting room using data and documents from PI, PASSPORT and MERIDIUM. The final HAZOP procedures were documented by a scribe in the virtual meeting room and distributed by e-mail to appropriate actors.

A third application of the present invention was directed to training of plant operators. The trainees were trained and required to pass a test administered via the virtual conference room, and then required to physically enter the plant to identify a piece of equipment or maintenance activity. The use case involved using the virtual environment to train operations and maintenance staff on a new Sulfur Recovery Unit (SRU) of an oil refining facility.

Advantageously, the trainer and trainee were not co-located and were geographically separated. By being able to remotely train on virtual equipment, travel time and costs were reduced, and safety and productivity improved. Participants in the training session included a trainee, a trainer, a model manipulator, a facilitator, and scribe. Data required for this application included equipment maintenance history, data specifications, design conditions, current process conditions (out of PI).

Notwithstanding that the present invention has been described above in terms of alternative embodiments, it is anticipated that still other alterations, modifications and applications will become apparent to those skilled in the art after having read this disclosure. It is therefore intended that such disclosure be considered illustrative and not limiting, and that the appended claims be interpreted to include all such applications, alterations, modifications and embodiments as fall within the true spirit and scope of the invention

What is claimed is:

1. A system for conducting activities related to an industrial facility, the system comprising:
a collaboration environment server for executing a first set of computer instructions to produce a collaboration environment for a defined set of users and for defining one or more facility activities to be performed by the users, the first set of computer instructions comprising instructions for generating data representative of the users;
a virtualization environment server for executing a second set of computer instructions to produce a virtual representation of the industrial facility, the second set of computer instructions comprising instructions for generating data representative of the industrial facility;
a facility environment server for executing a third set of computer instructions to provide operations data related to the industrial facility, the third set of computer instructions comprising instructions for generating the operations data;
user terminals located at one or more locations remote from the facility in communication with the collaboration environment server, the virtualization environment server and the facility environment server for executing a fourth set of computer instructions for receiving and processing the data representative of the users, the data representative of the industrial facility, and the operations data; and
a user display device in communication with each of the user terminals for displaying an immersive visual environment of the facility to enable the users to collaboratively conduct the facility activities from the one or more remote locations.

2. The system according to claim 1, where the collaboration environment is a virtual meeting space and the data representative of the users are avatars.

3. The system according to claim 2, wherein the collaboration environment server comprises means for porting the avatars from the virtual meeting space into the virtual representation of the industrial facility.

4. The system according to claim 2, wherein the collaboration environment server comprises means for porting the virtual representation of the industrial facility into the virtual meeting space such that each of the users can view the virtual representation from the perspective of their respective avatars positioned within the virtual meeting space.

5. The system according to claim 1, wherein the collaboration environment server comprises means for creating a two dimensional virtual conference room having an entry point to the virtual representation.

6. The system according to claim 5, wherein the virtual representation of the industrial facility comprises a three dimensional model.

7. The system according to claim 5, wherein the virtual representation of the industrial facility comprises a video data from the industrial facility.

8. A computer-implemented method of conducting activities related to an industrial facility, the method comprising:
defining one or more facility activities to be performed by a defined set of users;
generating a collaboration environment for the users;
generating a virtual representation of the industrial facility;
providing operations data related to the industrial facility;
receiving and processing data representative of the users, data representative of the collaborative environment, the virtual representation, and the operations data, at locations remote to the facility; and
displaying an immersive visual environment using the user data, the collaborative environment, virtual representation, and operations data to enable the users to collaboratively conduct the facility activities from the remote locations.

9. The method according to claim 8, wherein the step of generating a collaborative environment includes providing a virtual meeting space and one or more avatars representative of the users.

10. The method according to claim 9, further comprising the step of porting the avatars from the virtual meeting space into the virtual representation of the industrial facility.

11. The method according to claim 9, further comprising the step of porting the virtual representation of the industrial facility into the virtual meeting space such that each of the users can view the virtual representation from the perspective of their respective avatars positioned within the virtual meeting space.

12. A computer program product, comprising computer usable media having a computer readable program code embodied therein, the computer readable program code adapted to be executed to implement a method of conducting activities related to an industrial facility, the method comprising:
defining one or more facility activities to be performed by a defined set of users;
generating a collaboration environment for the users;
generating a virtual representation of the industrial facility;
providing operations data related to the industrial facility;
receiving and processing data representative of the users, data representative of the collaborative environment, the virtual representation, and the operations data, at locations remote to the facility; and
displaying an immersive visual environment using the user data, collaborative environment, virtual representation, and operations data to enable the users to collaboratively conduct the facility activities from the remote locations.
